(19) United States
(12) Patent Application Publication
(10) Pub. No.: US 2026/0247391 A1
(43) Pub. Date: Aug. 20, 2026

(54) METHOD AND APPARATUS FOR SPECTRUM SHARING BETWEEN NETWORK TECHNOLOGIES

(71) Applicant: Huawei Technologies Co., Ltd., Shenzhen (CN)

(72) Inventors: Dongdong Wei, Shanghai (CN); Hao Tang, Ottawa (CA); Jianglei Ma, Ottawa (CA); Liqing Zhang, Ottawa (CA); Lei Dong, Shanghai (CN)

(21) Appl. No.: 19/548,833

(22) Filed: Feb. 24, 2026

Related U.S. Application Data
(63) Continuation of application No. PCT/CN2024/078601, filed on Feb. 26, 2024.

(30) Foreign Application Priority Data
Aug. 25, 2023 (WO) PCT/CN2023/114987

(51) Int. Cl. H04W 72/21; H04W 88/06

(52) U.S. Cl. CPC H04W 72/21; H04W 88/06

(57) ABSTRACT

Embodiments of the present application provide a method and apparatus for spectrum sharing between network technologies. The method includes: generating a physical uplink control channel (PUCCH) sequence; and mapping the PUCCH sequence to first PUCCH resource set, where the first PUCCH resource set includes part or all of a second PUCCH resource set associated with a second radio access technology.

### CROSS-REFERENCE TO RELATED APPLICATIONS

The present application is a continuation of International patent application No. PCT/CN2024/078601, filed on Feb. 26, 2024, and claims priority to International patent application No. PCT/CN2023/114987, filed on Aug. 25, 2023, both of which are hereby incorporated by reference in their entirety.

### TECHNICAL FIELD

Embodiments of the present application relate to the field of communications, and more specifically, to a method and apparatus for spectrum sharing between network technologies.

### BACKGROUND

With the emergence of a new generation of wireless communications, the new generation and old generation of wireless communications may be employed simultaneously, especially in the early stage of employment of the new generation. For example, a network device may communicate with terminal device(s) associated with a fifth generation (5G) technology (e.g. user equipment (UE)) and terminal device(s) associated with a sixth generation (6G) technology (e.g. 6G UE) simultaneously. In the initial employment of a new generation technology such as 6G technology, 5G UE(s) and 5G network(s) are likely to be utilized with the 6G UE(s) and 6G network(s). Multiple spectrums have been occupied by the existing 5G technology.

Therefore, an urgent technical problem that needs to be solved is how to improve resource utilization when multiple terminal devices associated with different radio access technologies co-exist.

### SUMMARY

Embodiments of the present application provide a method and apparatus for spectrum sharing between network technologies. The resource utilization can be improved when multiple terminal devices associated with different radio access technologies co-exist.

According to a first aspect, an embodiment of the present application provides a communication method, and the method may be performed by a first terminal device or a chip of the first terminal device. The first terminal device is associated with a first radio access technology. The method includes: generating a physical uplink control channel (PUCCH) sequence; and mapping the PUCCH sequence to a first PUCCH resource set, where the first PUCCH resource set includes part or all of a second PUCCH resource set associated with a second radio access technology.

For example, the first terminal device generates a PUCCH; and the first terminal device transmits the PUCCH based on a first PUCCH resource set, where the first PUCCH resource set includes part or all of a second PUCCH resource set associated with a second radio access technology.

According to a second aspect, an embodiment of the present application provides a communication method, and the method may be performed by a network device or a chip of the network device. The method includes: receiving a physical uplink control channel (PUCCH) on first PUCCH resource set from a first terminal device associated with a first radio access technology, where the first PUCCH resource set includes part or all of second PUCCH resource set associated with a second radio access technology.

According to the above technical solution, part or all of resources could be shared between terminal device(s) associated with a first radio access technology and terminal device(s) associated with the second radio access technology. The network device could serve multiple terminal devices associated with different generations of technology with the same part of PUCCH resource set. The resource utilization could be improved when multiple terminal devices associated with different radio access technologies co-exist.

With reference to the first aspect, in some embodiments, the method further includes: receiving first configuration information, where the first configuration information indicates the first PUCCH resource set among multiple PUCCH resource sets.

With reference to the second aspect, in some embodiments, the method further includes: transmitting first configuration information, where the first configuration information indicates the first PUCCH resource set among multiple PUCCH resource sets.

According to the above technical solution, the first terminal device may support multiple PUCCH resource sets, the network device could indicate the first PUCCH resource set to the first terminal device, and the first terminal device could use the first PUCCH resource set by the first configuration information.

With reference to the first aspect or the second aspect, in some embodiments, the first configuration information may indicate one or more offsets, and the one or more offsets are used for determining a position of the first PUCCH resource set in a frequency domain.

According to the above technical solution, the position of the first PUCCH resource set can be determined based on one or more offsets, and a simple and flexible configuration method is provided.

With reference to the first aspect or the second aspect, in some embodiments, one or more types are associated with the multiple PUCCH resource sets, and the first configuration information further indicates a type of the first PUCCH resource set.

For example, different types of the PUCCH resource sets may be predefined in different tables respectively, and the type of first PUCCH resource set could indicate the corresponding table.

With reference to the first aspect or the second aspect, in some embodiments, the multiple PUCCH resource sets include a third PUCCH resource set, and the third PUCCH resource set is dedicated to the first radio access technology.

According to the above technical solution, the design of the dedicated third PUCCH resource set may not consider the impact of the co-existence between the first radio access technology and the second radio access technology, which is flexible.

With reference to the first aspect or the second aspect, in some embodiments, a format associated with the first PUCCH resource set is different from a format associated with the third PUCCH resource set.

With reference to the first aspect or the second aspect, in some embodiments, a derivation of a position in a frequency domain and/or initial cyclic shift from the first PUCCH resource set is different from a derivation of a position in a frequency domain and/or initial cyclic shift from the second PUCCH resource set.

According to the above technical solution, the first terminal device and a second terminal device (associated with the second radio access technology) may determine the position in a frequency domain and/or initial cyclic shift in different ways.

With reference to the first aspect, in some embodiments, the method further includes: receiving second configuration information, where the second configuration information is used for configuring one or more PUCCH resource sets, and the one or more PUCCH resource sets include the first PUCCH resource set.

With reference to the second aspect, in some embodiments, the method further includes: transmitting second configuration information, where the second configuration information is used for configuring one or more PUCCH resource sets, and the one or more PUCCH resource sets include the first PUCCH resource set.

According to the above technical solution, the first terminal device may obtain one or more PUCCH resource sets from the second configuration information, and may choose the first PUCCH resource set from the one or more PUCCH resource sets.

With reference to the first aspect or the second aspect, in some embodiments, one or more PUCCH formats are associated with the one or more PUCCH resource sets.

For example, the network device may indicate one or more formats of the PUCCH resource sets to the first terminal device, and the first terminal device may determine a PUCCH format flexibly.

With reference to the first aspect or the second aspect, in some embodiments, the first PUCCH resource set is determined based on one or more of: a size of uplink control information (UCI); content of UCI; and configurations of the one or more PUCCH resource sets.

According to the above technical solution, the first terminal device or the network device can determine the first PUCCH resource set based on the above information properly, and the reliability can be improved.

With reference to the first aspect or the second aspect, in some embodiments, a first PUCCH sequence mapped in the first PUCCH resource set is code division multiplexed with a second PUCCH sequence mapped in the second PUCCH resource set.

With reference to the first aspect or the second aspect, in some embodiments, the first configuration information is carried in a system information block.

With reference to the first aspect or the second aspect, in some embodiments, the second radio access technology is a fifth generation (5G) radio access technology, and the first radio access technology is a sixth generation (6G) radio access technology.

According to a third aspect, a terminal device is provided. The terminal device includes a function or unit configured to perform the method according to the first aspect or any one of the possible embodiments of the first aspect.

According to a fourth aspect, a network device is provided. The network device includes a function or unit configured to perform the method according to the second aspect or any one of the possible embodiments of the second aspect.

According to a fifth aspect, a system is provided. The system includes: the terminal device according to the third aspect and the network device according to the fourth aspect.

According to a sixth aspect, a communication apparatus is provided. The communication apparatus includes at least one processor, and the at least one processor is coupled to at least one memory. The at least one memory is configured to store a computer program or one or more instructions. The at least one processor is configured to: invoke the computer program or the one or more instructions from the at least one memory and run the computer program or the one or more instructions, so that the communication apparatus performs the method in any one of the first aspect or the possible implementations of the first aspect, or the communication apparatus performs the method in any one of the second aspect or the possible implementations of the second aspect.

With reference to the sixth aspect, in some implementations of the sixth aspect, the communication apparatus may be a network device or a component (for example, a chip or an integrated circuit) installed in the network device. For another example, the communication apparatus may be a terminal device or a component (for example, a chip or an integrated circuit) installed in the terminal device.

With reference to the sixth aspect, in some implementations of the sixth aspect, the communication apparatus may be a terminal device or a component (for example, a chip or an integrated circuit) installed in the terminal device. For another example, the communication apparatus may be a network device or a component (for example, a chip or an integrated circuit) installed in the network device.

According to a seventh aspect, a communication apparatus is provided. The communication apparatus includes a processor and a communications interface. The processor is connected to the communications interface. The processor is configured to execute one or more instructions, and the communications interface is configured to communicate with other network elements under the control of the processor. The processor is enabled to perform the method according to the first aspect, any one of the possible embodiments of the first aspect, the second aspect, or any one of the possible embodiments of the second aspect.

According to an eighth aspect, a computer storage medium is provided. The computer storage medium stores program code, and the program code is used to execute one or more instructions for the method according to the first aspect, any one of the possible embodiments of the first aspect, the second aspect, or any one of the possible embodiments of the second aspect.

According to a ninth aspect, this application provides a computer program product including one or more instructions, where when the computer program product runs on a computer, the computer performs the method according to the first aspect, any one of the possible embodiments of the first aspect, the second aspect, or any one of the possible embodiments of the second aspect.

According to a tenth aspect, this application provides a non-transitory computer-readable medium storing instruction the instructions causing a processor in a device to implement the method according to the first aspect or any one of the possible embodiments of the first aspect, or the second aspect or any one of the possible embodiments of the second aspect.

According to an eleventh aspect, this application provides a device configured to perform the method according to the first aspect or any one of the possible embodiments of the first aspect, or the second aspect or any one of the possible embodiments of the second aspect.

According to a twelfth aspect, this application provides a processor, configured to execute instructions to cause a device to perform the method according to the first aspect or any one of the possible embodiments of the first aspect, or the second aspect or any one of the possible embodiments of the second aspect.

According to a thirteenth aspect, this application provides an integrated circuit configure to perform the method according to the first aspect or any one of the possible embodiments of the first aspect, or the second aspect or any one of the possible embodiments of the second aspect.

According to a fourteenth aspect, this application provides a communication apparatus, comprising a transceiver unit, configured to perform the receiving step according to the first aspect or any one of the possible embodiments of the first aspect, and a processing unit, configured to perform the processing step according to the first aspect or any one of the possible embodiments of the first aspect.

According to a fifteenth aspect, this application provides a communication apparatus, comprising a transceiver unit, configured to perform the transmitting step according to the second aspect or any one of the possible embodiments of the second aspect.

### DESCRIPTION OF THE DRAWINGS

FIG. 1 is a schematic diagram of an application scenario according to this application;

FIG. 2 illustrates an example communications system 100;

FIG. 3 illustrates another example of an ED and a base station;

FIG. 4 illustrates units or modules in a device;

FIG. 5 illustrates a first embodiment of spectrum sharing between two technologies;

FIG. 6 illustrates a second embodiment of spectrum sharing between two technologies;

FIG. 7 illustrates a third embodiment of spectrum sharing between two technologies;

FIG. 8 is a schematic flowchart of a communication method according to an embodiment of this application;

FIG. 9 illustrates a first example of 6G PUCCH resources and 5G PUCCH resources according to an embodiment of this application;

FIG. 10 illustrates a second example of 6G PUCCH resources and 5G PUCCH resources according to an embodiment of this application;

FIG. 11 illustrates a third example of 6G PUCCH resources and 5G PUCCH resources according to an embodiment of this application;

FIG. 12 illustrates a schematic diagram of additional offsets for 6G PUCCH according to an embodiment of this application; and

FIGS. 13-14 are schematic block diagrams of possible devices according to embodiments of this application.

### DETAILED DESCRIPTION OF THE ILLUSTRATIVE EMBODIMENTS

The following describes technical solutions of the present application with reference to the accompanying drawings.

The technical solutions in embodiments of this application may be applied to various communications systems, such as a Global System for Mobile Communications (GSM), a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, a wireless local area network (WLAN), a fifth generation (5G) wireless communications system, a new ratio (NR) wireless communications system, a sixth generation (6G) wireless communications system, or other evolving communications systems.

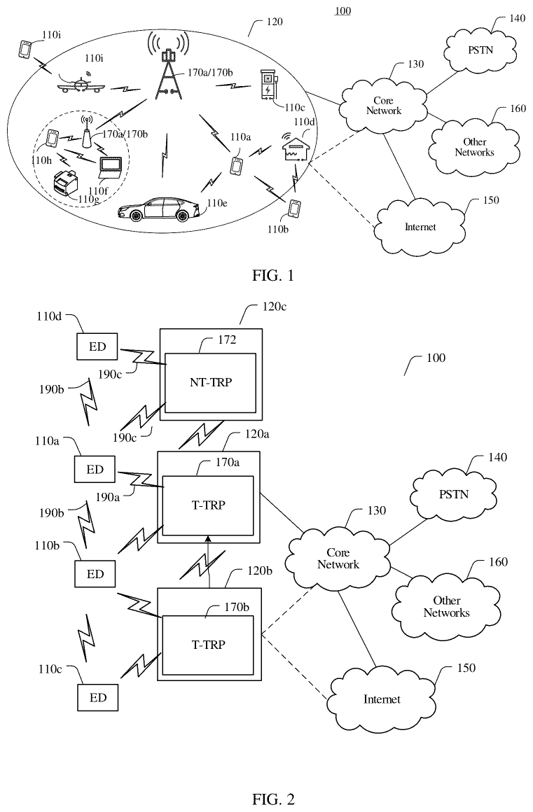

For ease of understanding the embodiments of this application, a communications system shown in FIGS. 1-3 is first used as an example to describe in detail a communications system to which the embodiments of this application are applicable.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

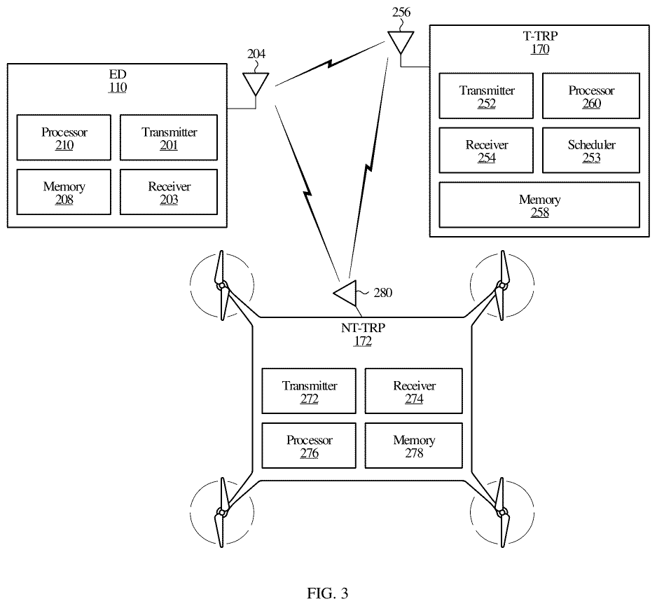

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some embodiments, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

The CU (or CU-control plane (CP) and CU-user plane (UP)), DU or RU may be known by other names in some embodiments. For example, in open RAN (ORAN) system, the CU may also be referred to as open CU (O-CU), DU may also be referred to as open DU (O-DU), CU-CP may also be referred to open CU-CP (O-CU-CP), CU-UP may also be referred to as open CU-UP (O-CU-CP), and RU may also be referred to open RU (O-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some embodiments, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

For ease of understanding the embodiments of this application, the following briefly describes a process of transmitting reference signals and measuring channels based on the reference signals.

Multiple input multiple-output (MIMO) technology allows an antenna array of multiple antennas to perform signal transmissions and receptions to meet high transmission rate requirements. The above ED110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves dozens of the ED 110 (such as 40). A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increased number of antennas allows each antenna unit to be smaller in size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is reduced, and the power efficiency is increased. When the antenna number of the T-TRP 170, and/or NT-TRP 172 is sufficiently large, random channels between each ED 110 and the T-TRP 170, and/or NT-TRP 172 can approach orthogonal, and the interference between the cell and the users and the effect of noises can be eliminated. The plurality of advantages described above enable large-scale MIMO systems to have good prospects for application.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

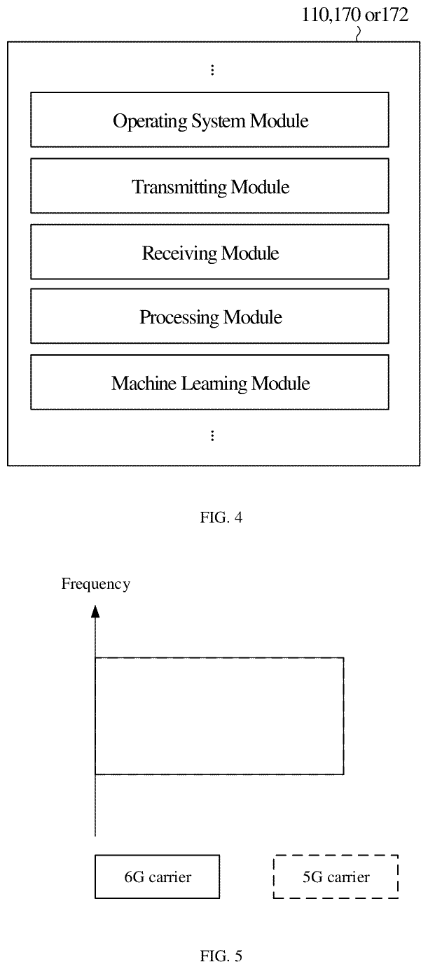

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xxo:yyo:zz), to a frame boundary, where xxo, yyo, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

The term “downlink” is used to denote the direction from the network device (170,172) to the terminal device (110), and the term “uplink” is used to denote the direction from the terminal device (110) to the network device (170,172).

Embodiments of this application can be applied to any communication scenario where a network device (e.g. T-TRP or NT-TRP) communicates with one or more terminal devices (e.g. ED). With the emergence of new generation of wireless communications, the new generation and old generation of wireless communications may be employed simultaneously, especially in the early stage of employment of a new generation. For example, a network device may communicate with terminal device(s) associated with a 5G technology (e.g. 5G UE) and terminal device(s) associated with a 6G technology (e.g. 6G UE) simultaneously. For ease of understanding of this application, the following embodiments are illustrative of a network device communicating with a first terminal device (e.g. 6G UE), and the network device may communicate with a second terminal device (e.g. 5G UE) alternatively.

In the initial employment of the new generation technology such as the 6G technology, 5G UE(s) and 5G network(s) are likely to be employed with the 6G UE(s) and 6G network(s). Multiple spectrums have been occupied by the existing 5G technology. In order to improve the spectrum coverage of the new generation technology, it is important to design spectrum sharing between multiple generations of technology.

Spectrum sharing implies that multiple radio access technologies could share the same spectrum. That is, there is a spectrum that multiple types of UEs (e.g. 5G UE and 6G UE) can use to transmit channels or signals. For example, one or more carriers can be allocated to 5G UE(s) to transmit channels and signals and can be named as 5G carrier(s). One or more carriers can be allocated to 6G UE(s) to transmit channels or signals and can be named as 6G carrier(s). The 5G carrier(s) and 6G carrier(s) may overlap partially or fully. For ease of understanding the embodiments of this application, three cases of spectrum sharing between 5G technology (UE(s)) and 6G technology (UE(s)) are shown in FIGS. 5-7.

FIG. 5 illustrates a first embodiment of spectrum sharing between two technologies, for example 5G technology (5G UE(s)) and 6G technology (6G UE(s)). As shown in FIG. 5, a 6G carrier can overlap fully with a 5G carrier. In other words, the 5G carrier and 6G carrier can be located in a same frequency. The 6G UE(s) could reuse all of the 5G carrier.

FIG. 6 illustrates a second embodiment of spectrum sharing between two technologies, for example 5G technology (5G UE(s)) and 6G technology (6G UE(s)). As shown in FIG. 6, a 6G carrier can overlap partially with a 5G carrier. In other words, 6G UE(s) could reuse part of the 5G carrier.

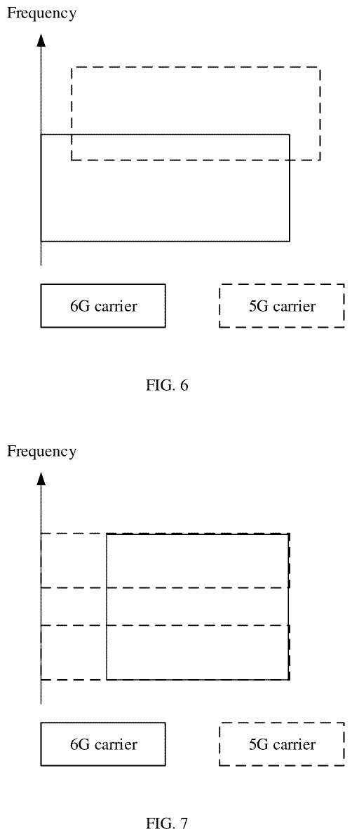

FIG. 7 illustrates a third embodiment of spectrum sharing between two technologies, for example 5G technology (5G UE(s)) and 6G technology (6G UE(s)). As shown in FIG. 7, a 6G carrier can overlap with two 5G carriers (e.g. 5G carrier 1 and 5G carrier 2). In other words, 6G UE(s) could reuse part or all of multiple 5G carriers.

In some embodiments, spectrum sharing could be implemented in a static manner or a dynamic manner. The shared spectrum may include multiple carriers, and a carrier in the shared spectrum is for which technology is dedicated when the static manner is implemented. The dynamic spectrum sharing (DSS) implies that multiple radio access technologies share the same spectrum, but how much of the spectrum is allocated to which radio access technology (5G or 6G) may be not fixed.

In 4G-5G DSS, frequency division multiplexing (FDM) and time division multiplexing (TDM) are supported, which can reduce conflict between the 4G UE(s) and 5G UE(s). However, 4G UE(s) and 5G UE(s) occupy a lot of resources to transmit channels and signals respectively.

Therefore, this application provides a communication method in which UEs associated with different generations of technologies can use the same resources to transmit channel(s) or signal(s), to improve resource utilization.

More specifically, this application provides a communication method in which UEs associated with different generations of technologies can use at least part of the same resource for a physical uplink control channel (PUCCH), to improve resource utilization.

A PUCCH is an important uplink channel, which can carry uplink control information (UCI). A terminal device could transmit a PUCCH to a network device, and the network device may receive the PUCCH.

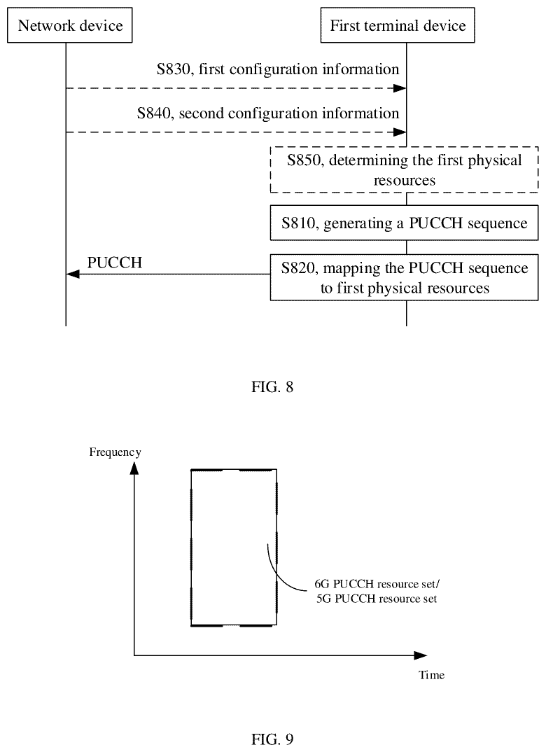

FIG. 8 is a schematic flowchart of a communication method according to an embodiment of this application. The communication method may be applied to the communications system described above.

At S810, a first terminal device generates a PUCCH sequence.

At S820, the first terminal device maps the PUCCH sequence to a first PUCCH resource set. Correspondingly, the network device receives the PUCCH sequence from the first terminal device.

The first PUCCH resource set include all or part of second PUCCH resource set associated with a second radio access technology. That is, part or all of resources could be shared between terminal device(s) associated with the first radio access technology and terminal device(s) associated with the second radio access technology. The network device could serve multiple terminal devices associated with different generations of technology with the same part of PUCCH resource set. The resource utilization could be improved when multiple terminal devices associated with different generations of technology co-exist.

It is noted that a sequence could be used in many ways to generate a specific sequence itself (e.g., reference signals) or to scramble data of a specific channel. A device could generate a sequence according to various implementations of this sequence. When a device generates a sequence implemented in PUCCH, the sequence can be referred to as PUCCH sequence. Moreover, the first terminal device mapping the PUCCH sequence to the first PUCCH resource set can refer to the first terminal device transmits the PUCCH based on the PUCCH resource set, or the first terminal device uses the first PUCCH resource set to transmit the PUCCH.

The first terminal device may be associated with a first radio access technology. In some embodiments, the first radio access technology and the second radio access technology are two generations of radio access technology. For example, the first radio access technology corresponds to the 6G technology, and the second radio access technology corresponds to the 5G technology. A 6G UE may be an example of the first terminal device and a 5G UE may be an example of the second terminal device in embodiments below. The network device can serve both the 5G UE(s) and 6G UE(s).

It is noted that embodiments of this application take 5G technology and 6G technology as examples. The first terminal device may be associated with another technology. The first part may be shared among terminal devices associated with three or more kinds of technology. This is not limited in this application.

It is noted that the “first PUCCH resource set” is only named for differentiation and does not limit the scope of protection of the embodiments of this application. Similarly, “second configuration”, and a “first terminal device”, etc. in the following description are also only named for differentiation and do not limit the scope of protection of the embodiments of this application, and this will not be repeated below.

It is noted that the PUCCH resource set may be referred to as time-frequency resources allocated to PUCCH transmission. A PUCCH resource set may include time-frequency resources, and a terminal device could use the time-frequency resources to transmit a PUCCH.

In some embodiments, the first PUCCH resource set include part or all of second PUCCH resource set associated with a second radio access technology (e.g. 5G technology). For example, the first PUCCH resource set may overlap completely with the second PUCCH resource set (with 5G PUCCH resource set for example below), or the first PUCCH resource set is a subset of the 5G PUCCH resource set, or the 5G PUCCH resource set is a subset of the first PUCCH resource set.

Alternatively, the first PUCCH resource set may overlap completely with the 5G PUCCH resource set. The multiple PUCCH resource sets further include a fourth PUCCH resource set. The fourth PUCCH resource set is a subset of the 5G PUCCH resource set, or the 5G PUCCH resource set is a subset of the fourth PUCCH resource set.

In some embodiments, the indication information may indicate a third PUCCH resource set among the multiple PUCCH resource sets, where the third PUCCH resource set is dedicated to terminal device(s) associated with the first radio access technology. The third PUCCH resource set may not overlap with a second PUCCH resource set associated with the second radio access technology. For example, a 6G UE may be configured with a third PUCCH resource set, and the third PUCCH resource set may not be shared with 5G UE(s). The design of the dedicated third PUCCH resource set may not consider the impact of the co-existence between the first radio access technology and the second radio access technology.

In some embodiments, the third PUCCH resource set may time division multiplexed (TDM) with the second PUCCH resource set. Alternatively, the third PUCCH resource set may frequency division multiplexed (FDM) with the second PUCCH resource set. The number of resource blocks (RBs) of the third PUCCH resource set and the second PUCCH resource set may be the same or different. This is not limited in this application.

For ease of understanding of embodiments of this application, the first PUCCH resource set, third PUCCH resource set, fourth PUCCH resource set and other possible PUCCH resource sets will hereafter be referred to a 6G PUCCH resource set. Possible implementations of 6G PUCCH resource set combined with a 5G PUCCH resource set in time-frequency domain are given below.

As shown in FIG. 9, 6G PUCCH resource set and 5G PUCCH resource set may overlap completely in the time-frequency domain. The 6G PUCCH resource set include all of the 5G PUCCH resource set. The resources could be shared with 5G UE(s) and 6G UE(s). The network may transmit one copy of PUCCH to serve 5G UE(s) and 6G UE(s) simultaneously. The resource utilization can be improved.

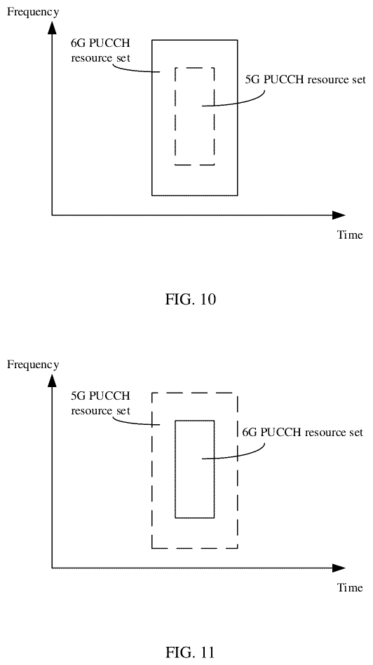

As shown in FIG. 10, 5G PUCCH resource set may be nested within 6G PUCCH resource set. The 5G PUCCH resource set is a subset of the 6G PUCCH resource set. The number of REs of the 6G PUCCH resource set is greater than the number of resource elements (REs) of the 5G PUCCH resource set, and the 6G UE may get better performance compared to the 5G UE.

As shown in FIG. 11, 6G PUCCH resource set may be nested within 5G PUCCH resource set. The 6G PUCCH resource set is a subset of the 5G PUCCH resource set. The number of REs of the 6G PUCCH resource set is smaller than the number of REs of the 5G PUCCH resource set, and the 6G UE may save more power compared to the 5G UE.

Although not illustrated, 6G PUCCH resource set may not overlap with 5G PUCCH resource set. The 6G PUCCH resource set may be dedicated to the 6G UE. This is not limited in this application.

In some embodiments, the first terminal device may work in one or more modes, and one or more 6G PUCCH resource sets may be associated with any one of the modes. For example, the first terminal device may work in two modes, such as a first mode and a second mode. When the first terminal device (e.g. a 6G UE) works in the first mode, the 6G UE may use PUCCH resource set who overlaps completely with the 5G PUCCH resource set, such as the 6G PUCCH resource set shown in FIG. 9. When the 6G UE works in the second mode, the 6G UE may use 6G PUCCH resource set who do not overlap with 5G PUCCH resource set. The first mode may be referred to as a 5G-like mode or 5G-enhanced mode, the second mode may be referred to as a 6G-pure mode, and this is not limited in embodiments of this application.

For another example, the first terminal device may work in three modes, such as a first mode, a second mode and a third mode. When the first terminal device (e.g. a 6G UE) works in the first mode, the 6G UE may use PUCCH resource set who overlaps completely with the 5G PUCCH resource set, such as the 6G PUCCH resource set shown in FIG. 9. When the 6G UE may work in the second mode, the 6G UE may use 6G PUCCH resources who contain 5G PUCCH resources or the 6G UE may use 6G PUCCH resources who may be part of the 5G PUCCH resources, as shown in FIG. 10 and FIG. 11. When the 6G UE may work in the third mode, the 6G UE may use 6G PUCCH resources who do not overlap with 5G PUCCH resources. The first mode may be referred to as a 5G-like mode, the second mode may be referred to as a 5G-enhanced mode and the third mode may be referred to as a 6G-pure mode.

One or more PUCCH resource sets associated with a first mode may be referred to as a first type of PUCCH resource set(s), one or more PUCCH resource sets associated with a second mode may be referred to as a second type of PUCCH resource set(s), and so on.

The time-frequency resources associated with the 6G technology have been described above. The first terminal device may generate a PUCCH sequence, and map the PUCCH sequence to the time-domain resources. In some embodiments, when the first PUCCH resource set and the second PUCCH resource set may overlap completely in the time-frequency domain (as shown in FIG. 9), the PUCCH sequence mapped in the first PUCCH resource set may be code division multiplexed (CDM) with the PUCCH sequence mapped in the second PUCCH resource set.

In some embodiments, a set of parameters may be associated with the first PUCCH resource set. The set of parameters may include one or more of:
a first parameter, which may indicate a PUCCH format;
a second parameter (e.g. first symbol), which may indicate a starting position of the first PUCCH resources set in the time domain (e.g. indicate the starting symbol);
a third parameter (e.g. number of symbols), which may indicate a duration of the first PUCCH resource set;
a fourth parameter (e.g. a PRB offset), which may indicate a starting position of the first PUCCH resource set in the frequency domain (e.g. indicate the starting PRB);
a fifth parameter (e.g. a set of initial cyclic shift indexes), which may be used for determining the position of the first PUCCH resource set in the frequency domain;
a sixth parameter (e.g. a PUCCH type), which may indicate a type of the first PUCCH resource set; and
a seventh parameter (e.g. offset(s)), which may indicate one or more offsets between the first PUCCH resource set and the second PUCCH resource set.

One or more parameters of the set of parameters may be carried in dynamical indication (e.g. in physical layer control signaling such as downlink control Information (DCI)), or semi-static indication (e.g. radio resource control (RRC) signaling or medium access control (MAC) layer), or be predefined based on the application scenario, or be determined by the UE as a function of other parameters that are known by the UE, or may be predefined (e.g. by a standard). This is not limited in this application.

The first terminal device may determine the time-frequency resources for PUCCH transmission based on one or more of the above parameters. It is noted that the parameters above are for illustrative purposes, and other parameter(s) used for determining the first PUCCH resource set are not excluded in this application.

For example, the position of the PUCCH resources in the frequency domain may be determined based on the PRB offset, an index r_{PUCCH} and the total number of initial cyclic shift indexes in the set of initial cyclic shift indexes (which is represented by N_{CS}). The index r_{PUCCH} and the initial cyclic shift are parameters that can be used to determine a position of a PUCCH resource set in the frequency domain (refer to formulas (1-2) below). The index r_{PUCCH} can be determined based on the number of CCEs in a CORESET of a PDCCH reception with the DCI, the index of a first CCE for the PDCCH reception, and the value of the PUCCH resource indicator field in the DCI format. The index r_{PUCCH} and N_{CS} could be used to determine a cyclic shift index in the set of initial cyclic shift indexes, where the set of initial cyclic shift indexes may be obtained from a table (e.g. Table 1 below). At least part of DCI is located in a PDCCH, and the DCI is used for scheduling physical resources for downlink data and uplink data.

In some embodiments, one or more parameters used for generating a PUCCH sequence may be also associated with the first PUCCH resource set. For example, a parameter indicating a code type may be associated with the first PUCCH resource set. This is not limited in this application.

The one or more parameters associated with the first PUCCH resource set are not limited in this application. For example, when 6G PUCCH resource set overlap fully with 5G PUCCH resource set in time-frequency domain, part or all of the above parameters may also be shared between the 5G PUCCH and the 6G PUCCH (e.g. parameters indicating the time-frequency resources could be shared). For another example, when the 5G PUCCH resource set is nested within the 6G PUCCH resource set, the 6G PUCCH resource set may include the first part (i.e. the 5G PUCCH resource set) and a second part, and a set of parameters may be shared between the first part of the 6G PUCCH resource set and the 5G PUCCH resource set. Alternatively, another dedicated set of parameters may be associated with the second part of the 6G PUCCH resource set.

In some embodiments, the above parameters may be predefined. For ease of understanding of this application, an example of the above parameters is illustrated in Table 1:

TABLE 1

| | PUCCH | First | Number of | | Set of initial |
|---|---|---|---|---|---|
| Index | format | symbol | symbols | PRB offset | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |

A row in Table 1 may be considered as configurations of a PUCCH resource set, where the configurations may include the parameters indicating the physical resources. In some embodiments, the network device could indicate an index of a PUCCH resource set to the first terminal device, and the first terminal device could obtain the PUCCH resource set based on the indicated index. That is, before step 810, the network device and the first terminal device may further perform the step 830.

Optionally, Δt S830, the network device transmits first configuration information to the first terminal device. Correspondingly, the first terminal device receives the configuration information from the network device.

The first configuration information may indicate the first PUCCH resource set. For example, the first configuration information may indicate an index of the first PUCCH resource set. When the first PUCCH resource set is determined, the PUCCH format, the time and frequency resources for PUCCH, and the cyclic shift for PUCCH transmission can also be determined, as shown in Table 1. Alternatively, the configurations may include one or more parameters used for determining the first PUCCH resource set, or include the index of PUCCH resource set and one or more parameters. This is not limited in this application.

For example, a table of multiple PUCCH resource sets (e.g. Table 1) may be predefined for 5G UE(s) and 6G UE(s). The network device could transmit the configuration information to the 5G UE(s) and 6G UE(s), and the configuration information could indicate a PUCCH resource set. The 5G UE(s) and 6G UE(s) could obtain the same PUCCH resource set based on the configuration information, and share the same physical resources for transmitting a PUCCH. The resource utilization could be improved.

It is noted that a position of the PUCCH resource in the frequency domain may be determined based on the PRB offset. For example, the PRB offset may indicate the number of PRB(s) with respect to a reference point. The reference point may be the starting position of initial uplink (UL) bandwidth part (BWP), or staring position of a control resource set o. When the reference point for the 6G UE(s) is different from the reference point for 5G UE(s), the 5G PUCCH and 6G PUCCH may be not aligned without additional information. Therefore, one or more offsets in addition to the PRB offset of the indicated PUCCH resource set may be further indicated by the first configuration information.

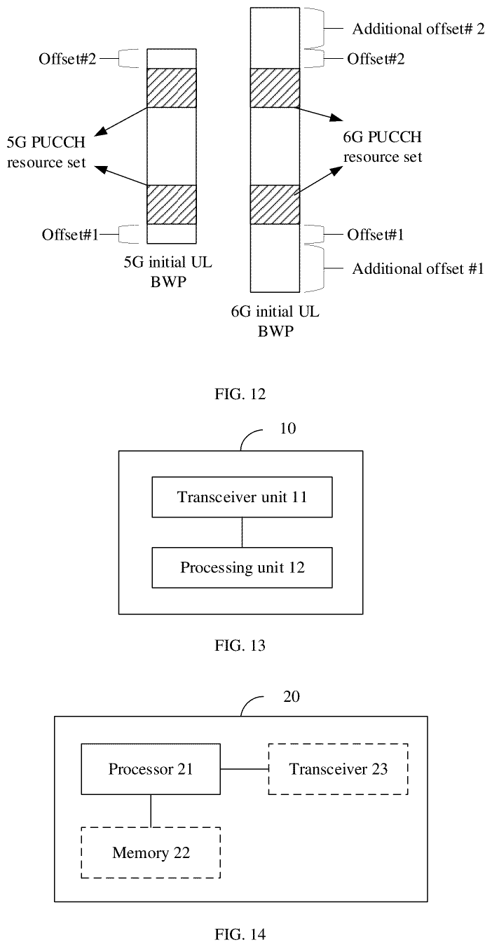

For example, FIG. 12 illustrates a schematic diagram of the one or more offsets for 6G PUCCH. As shown in FIG. 12, the 5G initial UL BWP is within the 6G initial UL BWP. An offset between the starting position of the 5G initial UL BWP and the starting position of the 5G PUCCH resources in the frequency domain may be represented by offset #1. Optionally, the offset between the ending position of the 5G initial UL BWP and the ending position of the 5G PUCCH resources in the frequency domain may be represented by offset #2. The starting position of the 6G initial UL BWP and the starting position of the 6G PUCCH resources in the frequency domain may include: the offset #1, and an offset between the starting position of the 6G initial UL BWP and the starting position of the 5G initial UL BWP (represented as additional offset #1 in FIG. 12). The ending position of the 6G initial UL BWP and the ending position of the 6G PUCCH resources in the frequency domain may include: the offset #1, and an offset between the ending position of the 6G initial UL BWP and the ending position of the 5G initial UL BWP (represented as additional offset #2 in FIG. 12).

In some embodiments, the PUCCH hopping in the frequency domain may be enabled. Refer to FIG. 12, the PUCCH frequencies include a first frequency hop and a second frequency hop. The first frequency hop could be determined based on the offset #1 and the additional offset #1, and the second frequency hop could be determined based on the offset #2 and the additional offset #2.

For example, when the additional offsets (additional offset #1 and additional offset #2) are configured, the determination of the lowest PRB index of the PUCCH transmission in the first hop may be related to the PRB index (i.e. offset #1) and additional offset. The lowest PRB index of the PUCCH transmission in the first hop may be:

$$( {RB}_{BWP}^{offset} + {Δ}_{offset 1} ) \cdot {N}_{RB} + ⌊ {r}_{PUCCH} / {N}_{CS} ⌋ \cdot {N}_{RB} \qquad ( 1 )$$

where

$${RB}_{BWP}^{offset}$$

may represent the PRB offset, Δ_{offset1} may represent the additional offset #1, and N_{RB} may represent the number of RBs for the PUCCH resource set.

When the PUCCH hopping is enabled, the lowest PRB index of the PUCCH transmission in the second hop may be:

$${N}_{BWP}^{size} - {RB}_{BWP}^{offset} \cdot {N}_{RB} - ( 1 + ⌊ {r}_{PUCCH} / {N}_{CS} ⌋ ) \cdot {N}_{RB} - {Δ}_{offset 2} \cdot {N}_{RB} \qquad ( 2 )$$

where

$${N}_{BWP}^{size}$$

may represent the number or RB(s) of the BWP, and Δ_{offset2} may represent the additional offset #2.

The index r_{PUCCH} in the formula (1) and formula (2) may be determined based on:

$${r}_{PUCCH} = ⌊ \frac{2 \cdot {n}_{CCE , 0}}{{N}_{CCE}} ⌋ + 2 \cdot {Δ}_{PRI} \qquad ( 3 )$$

where N_{CCE} may represent the number of CCEs in the CORESET of a PDCCH reception with the DCI, n_{CCE,0} may represent the index of a first CCE for the PDCCH reception, and Δ_{PRI} may represent the value of the PUCCH resource indicator field in the DCI format.

The above determining of the lowest PRB index of the PUCCH transmission in the first hop and the second hop is for illustrative purposes. The first terminal device may use other way(s) to determine the lowest PRB index of the PUCCH transmission. For example, when [r_{PUCCH}/8]=0, the first terminal device may determine the lowest PRB index of the PUCCH transmission in the first hop and the second hop based on the formulas (1) and (2). When [r_{PUCCH}/8]=1, the first terminal device may determine the lowest PRB index of the PUCCH transmission in the first hop as

$${N}_{BWP}^{size} - {RB}_{BWP}^{offset} \cdot {N}_{RB} - ( 1 + ⌊ ( {r}_{PUCCH} - 8 ) / {N}_{CS} ⌋ ) \cdot {N}_{RB} - {Δ}_{offset 1} \cdot {N}_{RB} ,$$

and the lowest PRB index of the PUCCH transmission in the second hop as

$$( R {B}_{BWP}^{offset} + {Δ}_{offset 2} ) \cdot {N}_{RB} + ⌊ ( {r}_{PUCCH} - 8 ) / {N}_{CS} ⌋ \cdot {N}_{RB} .$$

The first configuration information may indicate the offset #1, offset #2, additional offset #1 and additional offset #2 in a variety of ways. The 5G UE(s) can determine the 5G PUCCH resources (e.g. lowest PRB index) based on the offset #1 and the offset #2, and the 6G UE(s) can determine the 6G PUCCH resources (e.g. lowest PRB index) based on the offset #1, offset #2, additional offset #1 and additional offset #2. In some embodiments, the offset #1 and offset #2 may be indicated by the index of PUCCH resource set. For example, the offset #1 may be equal to the offset #2 and may be represented by a single offset, such as the PRB offset in Table 1.

In some embodiments, the values of the additional offset #1 and the additional offset #2 may be predefined. For example, multiple pairs of additional offset #1 and additional offset #2 may be allocated with multiple configured values (or indexes of the multiple pairs). The configuration information could indicate a configured value, and the 6G UE(s) could obtain the additional offset #1 and the additional offset #2. Alternatively, the configuration information may include the values of the additional offset #1 and the additional offset #2 explicitly. In some embodiments, the additional offset #1 may be equal to the additional offset #2, and the configuration information may indicate a single additional offset. This is not limited in this application.

In some embodiments, when the first PUCCH resource set are nested within the second PUCCH resource set (as shown in FIG. 12) or the second PUCCH resource set are nested within the first PUCCH resource set (as shown in FIG. 13), the one or more additional offsets may be further used to determine the offsets between the first PUCCH resource set and the second PUCCH resource set. This is not limited in this application.

One or more PUCCH resource sets associated with a first mode may be referred to as a first type of PUCCH resource set(s), one or more PUCCH resource sets associated with a second mode may be referred to as a second type of PUCCH resource set(s), and so on. The multiple types of PUCCH resource sets may be predefined in one or more tables.

In some embodiments, the multiple types of PUCCH resource sets may be predefined in multiple tables respectively. The first configuration information may further indicate a type of the PUCCH resource set. The first terminal device could determine the corresponding predefined table based on the type of the PUCCH resource set.

In some embodiments, a type of PUCCH resource set(s) may be configured as a default type. When there is no indication in the corresponding first configuration information or during a corresponding period, the first terminal device could use the default type of the table. For example, the 6G-pure type of PUCCH resource sets may be the default type. When the first terminal device does not receive information indicating other types (e.g. 5G-like mode), the first terminal could use the table associated with the 6G-pure type of PUCCH resource sets. Optionally, the default type of PUCCH resource sets may be associated with a frequency band. For example, the 6G-pure type of PUCCH resource sets may be associated with a first band. When the first terminal device works in the first band, the first terminal device may use the table associated with the 6G-pure type of PUCCH resource sets without additional indication. This is not limited in this application.

For ease of understanding embodiments of this application, two tables associated with two types of the PUCCH resource sets are illustrated here. For example, one of the two tables may be associated with the 5G-like mode, and another table may be associated with the 6G-pure mode. The above Table 1 may be considered as an example of the table associated with the 5G-like mode. The table associated with the 6G-pure mode may be illustrated as Table 2:

TABLE 2

| | PUCCH | First | Number of | | Set of initial |
|---|---|---|---|---|---|
| Index | format | symbol | symbols | PRB offset | CS indexes |
| 0 | 0a | 12 | 2 | 0 | {0, 3} |
| 1 | 0a | 12 | 2 | 0 | {0, 4, 8} |
| 2 | 0a | 12 | 2 | 3 | {0, 4, 8} |
| 3 | 1a | 10 | 4 | 0 | {0, 6} |
| 4 | 1a | 10 | 4 | 0 | {0, 3, 6, 9} |
| 5 | 1a | 10 | 4 | 2 | {0, 3, 6, 9} |
| 6 | 1a | 10 | 4 | 4 | {0, 3, 6, 9} |
| 7 | 1a | 4 | 10 | 0 | {0, 6} |
| 8 | 1a | 4 | 10 | 0 | {0, 3, 6, 9} |
| 9 | 1a | 4 | 10 | 2 | {0, 3, 6, 9} |
| 10 | 1a | 4 | 10 | 4 | {0, 3, 6, 9} |
| 11 | 1a | 0 | 14 | 0 | {0, 6} |
| 12 | 1a | 0 | 14 | 0 | {0, 3, 6, 9} |
| 13 | 1a | 0 | 14 | 2 | {0, 3, 6, 9} |
| 14 | 1a | 0 | 14 | 4 | {0, 3, 6, 9} |
| 15 | 1a | 0 | 14 | $⌊ {N}_{BWP}^{size} / 4 ⌋$ | {0, 3, 6, 9} |

A type of PUCCH resource sets (e.g. 5G-like type) are included in Table 1, and another type of PUCCH resource sets (e.g. 6G-pure type) are included in Table 2. In some embodiments, multiple types of PUCCH resource sets may differ in the PUCCH format (e.g. different PUCCH formats in Table 1 and Table 2). Optionally, the multiple types of PUCCH resource sets may differ in one or more of: PUCCH resources, first symbol, number of symbols, PRB offset and a set of initial cyclic shift indexes. This is not limited in this application.

It is noted that the number of tables predefined for PUCCH may be related to the types of PUCCH resource sets, and three or more tables may be predefined. For example, one of the three tables may be associated with the 5G-like mode, one table may be associated with the 5G-enhanced mode, and one table may be associated with the 6G-pure mode.

In some embodiments, the multiple types of PUCCH resource sets may be predefined in a single table. For example, a type of PUCCH resource sets associated with the 5G-like mode and a type of PUCCH resource sets associated with the 6G-pure mode may be included in a single table, for example Table 3:

TABLE 3

| | PUCCH | First | Number of | | Set of initial |
|---|---|---|---|---|---|
| Index | format | symbol | symbols | PRB offset | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $⌊ {N}_{BWP}^{size} / 4 ⌋$ | {0, 3, 6, 9} |
| 16 | 0a | 12 | 2 | 0 | {0, 3} |
| 17 | 0a | 12 | 2 | 0 | {0, 4, 8} |
| 18 | 0a | 12 | 2 | 3 | {0, 4, 8} |
| 19 | 1a | 10 | 4 | 0 | {0, 6} |
| 20 | 1a | 10 | 4 | 0 | {0, 3, 6, 9} |
| 21 | 1a | 10 | 4 | 2 | {0, 3, 6, 9} |
| 22 | 1a | 10 | 4 | 4 | {0, 3, 6, 9} |
| 23 | 1a | 4 | 10 | 0 | {0, 6} |
| 24 | 1a | 4 | 10 | 0 | {0, 3, 6, 9} |
| 25 | 1a | 4 | 10 | 2 | {0, 3, 6, 9} |
| 26 | 1a | 4 | 10 | 4 | {0, 3, 6, 9} |
| 27 | 1a | 0 | 14 | 0 | {0, 6} |
| 28 | 1a | 0 | 14 | 0 | {0, 3, 6, 9} |
| 29 | 1a | 0 | 14 | 2 | {0, 3, 6, 9} |
| 30 | 1a | 0 | 14 | 4 | {0, 3, 6, 9} |
| 31 | 1a | 0 | 14 | $⌊ {N}_{BWP}^{size} / 4 ⌋$ | {0, 3, 6, 9} |

As shown in Table 3, the type of PUCCH resource sets associated with the 5G-like mode may be the PUCCH resource sets with indexes 0-15 and PUCCH format 0 and format 1. The type of PUCCH resource sets associated with the 6G-dedicated mode may be the PUCCH resource sets with indexes 16-31 and PUCCH format 0a and format 1a. Different from multiple types of PUCCH resource sets included in multiple tables, information used for indicating the table could not be included in the configuration information, which could reduce the transmission consumption.

The determining of the position of the PUCCH resource in the frequency domain may be related to the indexes of rows in a table (e.g. Table 3). For example, the index r_{PUCCH}, which is used to determine the position of the PUCCH resource in the frequency domain, may be related to the indexes of rows. Optionally, the determining of the position of the PUCCH in the frequency domain may further be related to the additional offsets as described above.

In some embodiments, the calculation method for obtaining the index r_{PUCCH} may be different for different types of PUCCH resource sets. For example, for the 5G-like type of PUCCH resource sets (e.g. PUCCH resource sets with indexes smaller than 15), the index r_{PUCCH} may be obtained based on the above formula (3). For the 6G-pure type of PUCCH resource sets (e.g. PUCCH resource sets with indexes larger than 15), the index r_{PUCCH} may be obtained based on:

$${r}_{PUCCH} = ⌊ \frac{2 \cdot {n}_{CCE , 0}}{{N}_{CCE}} ⌋ + ( ( 2 \cdot {Δ}_{PRI} ) mod 8 ) \qquad ( 4 )$$

The first terminal device may transmit the first configuration information in a variety of ways. The first configuration information may be carried in one or more signals. For example, the first configuration information may be given by higher signaling (e.g. system information). The first configuration information may be carried in a system information block 1 (SIB1). The SIB1 may be associated with the first radio access technology (e.g. 6G technology). This is not limited in this application.

In some embodiments, the step 830 may be performed before RRC connection step. Multiple PUCCH resource sets can be predefined, and the first configuration information may indicate a PUCCH resource set among the predefined sets. In some embodiments, the network device could configure one or more dedicated PUCCH resource sets for the first terminal device, and the first terminal device could determine the first PUCCH resource set from the one or more dedicated PUCCH resource sets. That is, the network device and the first terminal device may further perform the following step S840.

Optionally, at S840, the network device transmits second configuration information to the first terminal device. Correspondingly, the first terminal device receives the second configuration information from the network device.

The second configuration information may indicate one or more PUCCH resource sets. PUCCH resources may be configured based on a PUCCH resource set. For example, the second configuration information may include parameter(s) used for determining the PUCCH resources. The first terminal device could determine the PUCCH resources based on the parameter(s) in the second configuration information.

In some embodiments, one or more formats may be associated with a single PUCCH resource set. For example, PUCCH format #1 (e.g. format 0 or format 1) and PUCCH format #2 (e.g. format 0a or format 1a) may be associated with a PUCCH resource set.

In some embodiments, PUCCH resources with part of the PUCCH formats can be shared between the 5G UE(s) and 6G UE(s), and the remaining part of the PUCCH formats can be dedicated to the 6G UE(s).

When the second configuration information configures multiple PUCCH resource sets, the first terminal device could choose a PUCCH resource set for PUCCH transmission. That is, the first terminal device may further perform the following step 850 optionally.

Optionally, at S850, the first terminal device determines the first PUCCH resources based on the second configuration information.

The first terminal device may determine a PUCCH resource set based on a size of UCI. In some embodiments, the UCI may include one or more of: a scheduling request (SR), HARQ ACK/NACK feedback, a rank indicator (RI), a precoding matrix indication (PMI), a CSI resource indicator (CRI), sensing results and artificial intelligence (AI) related data.

In some embodiments, the first terminal device determines a PUCCH resource set based on the size of UCL, and then the first terminal device may determine a PUCCH format associated with the PUCCH resource set.

For example, the PUCCH formats within the PUCCH resource set whose ID is equal to o can be shared between 5G and 6G. The PUCCH format(s) can be configured to be 5G-like or 6G-pure, and the 5G-like mode is configured to enable PUCCH sharing between 5G PUCCH and 6G PUCCH. In another example, the PUCCH formats which are used for hybrid automatic repeat request (HARQ) acknowledgment (ACK)/negative acknowledgment (NACK) feedback and in which the maximum number of UCI information bits is 2, can be shared between 5G and 6G. The PUCCH format(s) can be configured to be 5G-like or 6G-pure, and the 5G-like mode is configured to enable PUCCH sharing between 5G PUCCH and 6G PUCCH.

It is noted that the first PUCCH resource set may be obtained from the first configuration information or the second configuration information. For example, the first terminal device may determine the first PUCCH resource set based on the first configuration information before the RRC connection setup, or may determine the first PUCCH resource set based on the second configuration after the RRC connection setup.

In embodiments of this application, part or all of resources could be shared between terminal device(s) associated with the first radio access technology and terminal device(s) associated with the second radio access technology. The network device could serve multiple terminal devices associated with different generations of technology with the same part of PUCCH resources. The resource utilization could be improved when multiple terminal devices associated with different generations of technology co-exist.

The methods according to embodiments of this application are described above in detail with reference to FIGS. 8-12. The apparatuses provided in embodiments of this application are described below in detail with reference to FIGS. 13-14. The description of apparatus embodiments corresponds to the description of the method embodiments. Therefore, for content that is not described in detail, refer to the foregoing method embodiments. For brevity, details are not described herein again.

Referring to FIG. 13, a schematic block diagram of a communication apparatus according to an embodiment of this application is shown. The communication apparatus 10 includes a transceiver unit 11 and a processing unit 12. The transceiver unit 11 may implement a corresponding communication function, and the processing unit 11 is configured to perform data processing. The transceiver unit 11 may also be referred to as a communication interface or a communication unit.

In some embodiments, the communication apparatus 10 may further include a storage unit. The storage unit may be configured to store instructions and/or data. The processing unit 12 may read instructions and/or data in the storage unit, to enable the communication apparatus to implement the foregoing method embodiments.

The communication apparatus 10 may be configured to perform actions performed by the first terminal device in the foregoing method embodiments. In this case, the communication apparatus 10 may be the first terminal device or a component that can be configured in the first terminal device. The transceiver unit 11 is configured to perform communicating-related (e.g., receiving/transmitting-related) operations on the first terminal device side in the foregoing method embodiments. The processing unit 12 is configured to perform processing-related operations on the first terminal device side in the foregoing method embodiments.

The communication apparatus 10 may implement steps or procedures performed by the first terminal device in FIGS. 8-12 according to embodiments of this application. The communication apparatus 10 may include units configured to perform the method performed by the first terminal device in FIGS. 8-12. In addition, the units in the communication apparatus 10 and the foregoing other operations and/or functions are separately used to implement corresponding procedures in FIGS. 8-12.

Alternatively, the communication apparatus 10 may be configured to perform actions performed by the network device in the foregoing method embodiments. In this case, the communication apparatus 10 may be the network device or a component that can be configured in the network device. The transceiver unit 11 is configured to perform communicating-related (e.g., receiving/transmitting-related) operations on the network device side in the foregoing method embodiments. The processing unit 12 is configured to perform processing-related operations on the network device side in the foregoing method embodiments.

The communication apparatus 10 may implement steps or procedures performed by the network device in FIGS. 8-12 according to embodiments of this application. The communication apparatus 10 may include units configured to perform the method performed by the network device in FIGS. 8-12. In addition, the units in the communication apparatus 10 and the foregoing other operations and/or functions are separately used to implement corresponding procedures in FIGS. 8-12.

A specific process in which the units perform the foregoing corresponding steps is described in detail in the foregoing method embodiments. For brevity, details are not described herein again.

Referring to FIG. 14, a schematic block diagram of another communication apparatus according to an embodiment of this application is shown. The communication apparatus 20 includes a processor 21. The processor 21 is coupled to a memory 22. The memory 22 is configured to store a computer program or instructions and/or data. The processor 21 is configured to execute the computer program or instructions and/or data stored in the memory 22, so that the methods in the foregoing method embodiments are executed.

In some embodiments, the communication apparatus 20 includes one or more processors 21.

In an example, as shown in FIG. 14, the communication apparatus 20 may further include the memory 22.

In some embodiments, the communication apparatus 20 may include one or more memories 22.

In an example, the memory 22 may be integrated with the processor 21, or disposed separately from the processor 21.

In an example, as shown in FIG. 14, the communication apparatus 20 may further include a transceiver 23, where the transceiver 23 is configured to receive and/or transmit a signal. For example, the processor 21 may be configured to control the transceiver 23 to receive and/or transmit a signal.

In some embodiments, the communication apparatus 20 may be a first terminal device or a component (e.g., a chip, a circuit, or a processing system) that can be configured in the first terminal device; or the communication apparatus 20 may be a network device or a component (e.g., a chip, a circuit, or a processing system) that can be configured in the network device.

In a solution, the communication apparatus 20 is configured to perform the operations performed by the first terminal device in the foregoing method embodiments.

For example, the processor 21 may be configured to perform a processing-related operation performed by the first terminal device in the foregoing method embodiments, and the transceiver 23 may be configured to perform a communicating-related (e.g., receiving/transmitting-related) operation performed by the first terminal device in the foregoing method embodiments.

In another solution, the communication apparatus 20 is configured to perform the operations performed by the network device in the foregoing method embodiments.

For example, the processor 21 may be configured to perform a processing-related operation performed by the network device in the foregoing method embodiments, and the transceiver 23 may be configured to perform a communicating-related (e.g., receiving/transmitting-related) operation performed by the network device in the foregoing method embodiments.

An embodiment of this application further provides a computer-readable storage medium. The computer-readable storage medium stores computer instructions used to implement the method performed by the first terminal device or the method performed by the network device in the foregoing method embodiments.

For example, when the computer program is executed by a computer, the computer may be enabled to implement the method performed by the first terminal device or the method performed by the network device in the foregoing method embodiments.

An embodiment of this application further provides a computer program product including instructions. When the instructions are executed by a computer, the computer is enabled to implement the method performed by the first terminal device or the method performed by the network device in the foregoing method embodiments.

An embodiment of this application further provides a communication system. The communication system includes the first terminal device and the network device in the foregoing embodiments.

For explanations and beneficial effects of related content of any communication apparatus provided above, refer to a corresponding method embodiment provided above. Details are not described herein again.

The processor mentioned in embodiments of this application may be a central processing unit (CPU). The processor may further be another general-purpose processor, a digital signal processor (DSP), an application-specific integrated circuit (ASIC), a field programmable gate array (FPGA), or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM). For example, the RAM may be used as an external cache. By way of example but not limitation, the RAM may include a plurality of forms such as the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It should be noted that the term “receive” or “receiving” used herein may refer to receiving or otherwise obtaining from an element/component in same apparatus or from another device separate from the apparatus. Similarly, the term “transmit” or “transmitting” may refer to outputting or sending to/for an element/component in same apparatus or to/for another device separate from the apparatus. For example, any of the methods/procedures described herein may be performed by a chipset, in which case any sending or receiving steps may occur between elements of the chipset.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units may be integrated into one unit.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

What is claimed is:

1. A method, applied to a first terminal device associated with a first radio access technology, the method comprising:
generating a physical uplink control channel (PUCCH) sequence; and
mapping the PUCCH sequence to first PUCCH resource set, wherein the first PUCCH resource set comprises part or all of a second PUCCH resource set associated with a second radio access technology.

2. The method according to claim 1, further comprising:
receiving first configuration information, wherein the first configuration information indicates the first PUCCH resource set among multiple PUCCH resource sets.

3. The method according to claim 2, wherein the first configuration information indicates one or more offsets, and the one or more offsets are used for determining a position of the first PUCCH resource set in a frequency domain.

4. The method according to claim 2, wherein one or more types are associated with the multiple PUCCH resource sets, and the first configuration information further indicates a type of the first PUCCH resource set.

5. The method according to claim 2, wherein the multiple PUCCH resource sets comprise a third PUCCH resource set, and the third PUCCH resource set is dedicated to the first radio access technology.

6. The method according to claim 5, wherein a format associated with the first PUCCH resource set is different from a format associated with the third PUCCH resource set.

7. The method according to claim 5, wherein a derivation of a position in a frequency domain or initial cyclic shift from the first PUCCH resource set is different from a derivation of a position in a frequency domain or initial cyclic shift from the second PUCCH resource set.

8. The method according to claim 1, further comprising:
receiving second configuration information, wherein the second configuration information is used for configuring one or more PUCCH resource sets, and the one or more PUCCH resource sets comprise the first PUCCH resource set.

9. The method according to claim 8, wherein one or more PUCCH formats are associated with the one or more PUCCH resource sets.

10. The method according to claim 8, wherein the first PUCCH resource set is determined based on one or more of:
a size of uplink control information (UCI);
content of UCI; or
configurations of the one or more PUCCH resource sets.

11. A method, applied to a network device, the method comprising:
receiving a physical uplink control channel (PUCCH) on first PUCCH resource set from a terminal device associated with a first radio access technology, wherein the first PUCCH resource set comprises part or all of second PUCCH resource set associated with a second radio access technology.

12. The method according to claim 11, further comprising:
transmitting first configuration information, wherein the first configuration information indicates the first PUCCH resource set among multiple PUCCH resource sets.

13. The method according to claim 12, wherein the first configuration information indicates one or more offsets, and the one or more offsets are used for determining a position of the first PUCCH resource set in a frequency domain.

14. The method according to claim 12, wherein one or more types are associated with the multiple PUCCH resource sets, and the first configuration information further indicates a type of the first PUCCH resource set.

15. The method according to claim 12, wherein the multiple PUCCH resource sets comprise a third PUCCH resource set, and the third PUCCH resource set is dedicated to a first radio access technology.

16. The method according to claim 15, wherein a format associated with the first PUCCH resource set is different from a format associated with the third PUCCH resource set.

17. The method according to claim 15, wherein a derivation of a position in a frequency domain or initial cyclic shift from the first PUCCH resource set is different from a derivation of a position in a frequency domain or initial cyclic shift from a second PUCCH resource set.

18. The method according to claim 11, further comprising:
receiving second configuration information, wherein the second configuration information is used for configuring one or more PUCCH resource sets, and the one or more PUCCH resource sets comprise the first PUCCH resource set.

19. The method according to claim 18, wherein one or more PUCCH formats are associated with the one or more PUCCH resource sets.

20. A first terminal device associated with a first radio access technology, comprising at least one processor and memory storing one or more instructions which, when executed by the at least one processor, cause the first terminal device to:
generate a physical uplink control channel (PUCCH) sequence; and
map the PUCCH sequence to first PUCCH resource set, wherein the first PUCCH resource set comprises part or all of a second PUCCH resource set associated with a second radio access technology.
